(19) United States
(12) Patent Application Publication
(10) Pub. No.: US 2017/0256905 A1
(43) Pub. Date: Sep. 7, 2017

(54) DISTRIBUTED FEEDBACK LASER

(71) Applicants: Weihua GUO, Wuhan (CN); HUAZHONG UNIVERSITY OF SCIENCE AND TECHNOLOGY, Wuhan (CN)

(72) Inventors: Weihua GUO, Wuhan (CN); Gongyuan ZHAO, Wuhan (CN); Qiaoyin LU, Wuhan (CN)

(21) Appl. No.: 15/597,135

(22) Filed: May 16, 2017

Related U.S. Application Data
(63) Continuation-in-part of application No. PCT/CN2016/086143, filed on Jun. 17, 2016.

(30) Foreign Application Priority Data
Jun. 24, 2015 (CN) 201510354846.X

(51) Int. Cl. H01S 3/067; H01S 3/06; H01S 3/063

(52) U.S. Cl. CPC H01S 3/0675; H01S 3/0635; H01S 3/0623; H01S 3/1055

(57) ABSTRACT

A distributed feedback laser, including: an output end including an active region including a grating including a λ/4 phase-shift region; and a non-output end including a reflecting region including a grating with uniform period. The length of the active region is smaller than or equal to 200 μm. The end facet of the output end of the laser is coated with an anti-reflection film.

### CROSS-REFERENCE TO RELATED APPLICATIONS

This application is a continuation-in-part of International Patent Application No. PCT/CN2016/086143 with an international filing date of Jun. 17, 2016, designating the United States, now pending, and further claims foreign priority benefits to Chinese Patent Application No. 201510354846.X filed Jun. 24, 2015. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND OF THE INVENTION

Field of the Invention

The invention relates to a distributed feedback laser.

Description of the Related Art

Conventional λ/4 phase-shift distributed feedback lasers include anti-reflection films at two ends, and the power outputs at the two ends are equal. However, only the output from one end is usually coupled to optical fibers, which means that half of the output power is wasted.

In addition, to improve the direct modulation bandwidth of lasers, the cavity length of the lasers needs to be reduced. However, when the cavity length is reduced to 200 μm or below, the threshold gain increases sharply, which adversely affects the performance.

### SUMMARY OF THE INVENTION

In view of the above-described problems, it is one objective of the invention to provide a distributed feedback laser that has a relatively short cavity length (200 μm or less).

To achieve the above objective, in accordance with one embodiment of the invention, there is provided a distributed feedback laser. The distributed feedback laser comprises: an output end comprising an active region, the active region comprising a first grating, and the first grating comprising a λ/4 phase-shift region; and a non-output end comprising a reflecting region, the reflecting region comprising a second grating, and the second grating has a uniform period. The length of the active region is smaller than or equal to 200 μm. An end facet of the output end of the laser is coated with an anti-reflection film.

In a class of this embodiment, the second grating is a Bragg reflective grating having a period A calculated according to the following equation:

$$Λ = \frac{m λ}{2 {n}_{eff}}$$

in which, m represents a series number of the second grating; λ represents a Bragg wavelength corresponding to the second grating, at which the second grating is capable of producing a maximum reflection; and n_{eff} is an effective refractive index of a waveguide.

In a class of this embodiment, the series number of the second grating is m=1.

In a class of this embodiment, a waveguide of the reflecting region and a waveguide of the active region adopt the same core layer structures; and a waveguide core layer of the reflecting region adopts active quantum well materials. The quantum well material of the reflecting region is optically pumped into transparency by the emission from the laser itself, thus, an absorption loss of the quantum wells in the reflecting region is reduced to zero, the loss of the waveguide is therefore the internal loss of the waveguide of the active region and is approximately 20 cm⁻¹.

In a class of this embodiment, a length of the reflecting region is regulated by self-definition according to a required reflectivity; the length of the reflecting region and a reflectivity of the reflecting region are in positive correlation; and a maximum reflectivity of the reflecting region exceeds 80%, which is mainly restricted by the internal loss of the waveguide.

In a class of this embodiment, a coupling coefficient of the second grating of the reflecting region is regulated by self-definition according to a required reflectivity, unnecessary to be same as the coupling coefficient of the first grating in the active region; the coupling coefficient of the reflecting region and a reflectivity of the reflecting region are in positive correlation; and the coupling coefficient can be regulated to make the reflectivity of the reflecting region exceed 80%.

In a class of this embodiment, the period of the second grating of the reflecting region can be different from that of the first grating in the active region. Thus, even when the effective refractive indexes of the active region and the reflecting region are different, the Bragg wavelengths of the active region and the reflecting region can be regulated to be the same by regulating the period, that is, the peak wavelengths of the reflective peaks of both gratings are the same.

In a class of this embodiment, the non-output end of the laser in the reflecting region adopts a window section, or a horizontally inclined end facet, or a coated anti-reflection film, or a combination thereof to reduce the reflectivity.

In a class of this embodiment, a reflectivity of the anti-reflection film of the output end of the laser is smaller than 1% to reduce the reflectivity.

Advantages of the distributed feedback laser according to embodiments of the invention are summarized as follows:

The Bragg grating is introduced to the reflecting region to improve the feedback of the laser, which is equivalent to coat a high-reflecting film on an end facet of the active region, thus reducing the threshold gain, making the laser work at a short cavity length (200 μm or less), and improving the direct-modulation bandwidth of the laser. In addition, the slop efficiency of the output from the laser can be improved, and the reflective phase produced by the second grating of the reflecting region is controllable, thus not leading to the reduction of the side mode suppression ratio. In the meanwhile, the active region and the reflecting region adopt the same waveguide core layers, and the formation of the reflecting region does not require complicate butt-joint regrowth process any more, thus possessing reduced fabrication difficulties.

### BRIEF DESCRIPTION OF THE DRAWINGS

The invention is described hereinbelow with reference to the accompanying drawings, in which:

FIG. 1 is a structure diagram of a distributed feedback laser in accordance with one embodiment of the invention;

FIG. 2 is reflective spectra of a reflecting region with different lengths acquired from simulation in accordance with one embodiment of the invention;

FIG. 3A is a chart illustrating the effective index difference between the active region and the reflecting region, versus the threshold gain in accordance with one embodiment of the invention; and

FIG. 3B is a chart illustrating the effective index difference between the active region and the reflecting region, versus the threshold gain difference between a dominant mode and a side mode in accordance with one embodiment of the invention.

### DETAILED DESCRIPTION OF THE EMBODIMENTS

For further illustrating the invention, experiments detailing a distributed feedback laser are described below. It should be noted that the following examples are intended to describe and not to limit the invention.

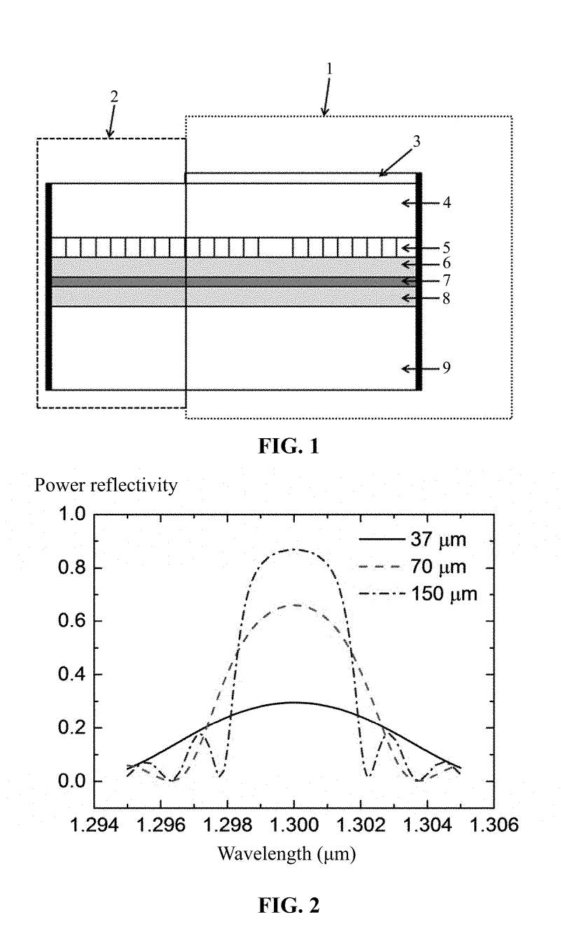

A distributed feedback laser having a short cavity length is illustrated in FIG. 1. The distributed feedback laser comprises: an active region 1, also called an optical gain region, and a reflecting region 2. The active region 1 comprises, from the top down: an electric contact layer 3, a waveguide upper cladding layer 4, a grating layer 5, an upper optical confinement layer 6, a Multi-quantum well layer 7, a lower optical confinement layer 8, and a waveguide lower cladding layer 9. The reflecting region 2, from the top down, comprises: a waveguide upper cladding layer 4, a grating layer 5, an upper optical confinement layer 6, a Multi-quantum well layer 7, a lower optical confinement layer 8, and a waveguide lower cladding layer 9. The grating layer of the active region comprises a λ/4 phase-shift region. The gratings at two sides of the phase-shift region are uniform gratings having the same period. The introduction of the λ/4 phase-shift region enables a Bragg wavelength to be a resonant wavelength of the laser cavity so as to be lasing wavelength of the laser. Therefore, the lasing wavelength of the laser can be controlled by accurately controlling the Bragg wavelength of the grating. Besides, as the grating is only able to provide the most effective reflection at the Bragg wavelength, the laser possesses good single-mode characteristics.

A section of uniformly distributed Bragg grating is introduced to a non-output end of the laser to form the reflecting region. The additional feedback of the reflecting region is able to reduce a threshold gain of the laser, therefore realizing a short cavity length. In addition, the feedback of the reflecting region increases an output power from the output end of the laser, so that a slop efficiency of the laser is improved.

A period A of the Bragg reflective grating is calculated according to the following equation:

$$Λ = \frac{m λ}{2 {n}_{eff}}$$

in which, m represents a series number of the grating, λ represents a Bragg wavelength corresponding to the grating where the grating is capable of producing a maximum reflection, and n_{eff} is an effective refractive index of a waveguide.

The feedback of the reflecting region is regulated via the following two means:

1. regulating a length of the section of the grating; under a certain coupling coefficient, the longer the length is, the larger the equivalent reflectivity of the reflecting region is.

2. regulating the coupling coefficient of the section of the grating; under a certain length of the grating, the larger the coupling coefficient is, the larger the equivalent reflectivity of the reflecting region is.

Theoretically, the two means are able to increase the reflectivity of the reflecting region to approaching 1. However, the waveguide exists with intrinsic loss, which makes the reflectivity smaller than 1. The loss of the waveguide is simulated and designed to be a typical value of 20 cm⁻¹ to acquire a relation between the wavelength and the equivalent reflectivity as shown in FIG. 2. It is known from the chart that the reflectivity at the Bragg wavelength exceeds 85%. As the grating is processed by high accuracy fabrication means, such as adopting the electron beam lithography technology, the reflection phase provided by the grating of the reflecting region can be accurately controlled, thus the feedback provided by the reflecting region and the feedback provided by the grating of the optical gain region are able to keep the same phase, ensuring that the laser is able to lase at a maximum feedback wavelength, which realizes the following effects: 1) the threshold of the laser can keep at a relatively low level, which is important when the cavity length reduces; 2) a lasing wavelength of the laser can be accurately controlled, through controlling the Bragg wavelength of the grating; and 3) the single-mode yield of the laser is high, as the lasing wavelength is always the wavelength that gets the highest feedback, which is the Bragg wavelength of the grating, and in contrast, the feedback of other wavelengths is much weaker, therefore, their threshold gain is much higher. The conventional cleaved facet coated with a high reflective film can easily provide a reflection exceeding 90%, which can reduce the threshold of the laser. However, as the position of the cleaved facet cannot be controlled accurate enough, it cannot be ensured to provide the reflection with the same phase as the grating of the optical gain region, resulting in inaccurate control of the lasing wavelength of the laser and serious problem of single-mode yield.

The reflecting region and the optical gain region of the distributed feedback laser in this invention comprise the same waveguide structure, and the waveguide core layers are both active layers 7. The difference is that the reflecting region does not have the metal electrode 3, current is not injected and gain cannot be acquired, thus only functioning in increasing the reflectivity of an end facet. No additional etching and regrowth technology are required by the process, which simplifies the fabrication process.

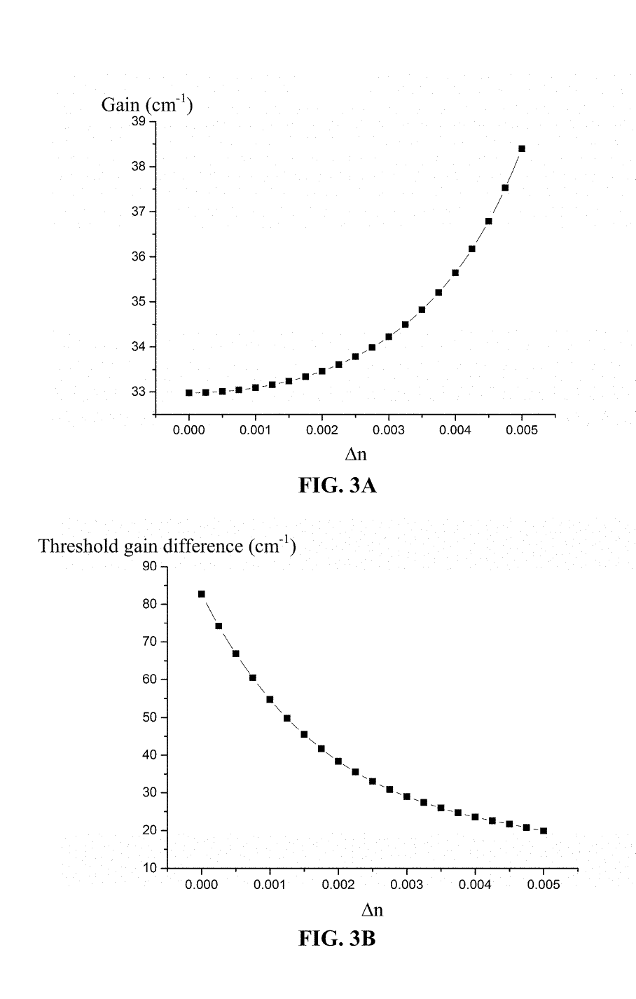

When current is not injected into the active region and the reflecting region of the distributed feedback laser, their effective refractive indexes should keep the same. When current is injected to the active region, the effective refractive index of the active region varies from that of the reflecting region. When the gratings of both the reflecting region and the active region adopts the same period, the Bragg wavelengths of the gratings of the two regions are slightly different from each other, resulting in reduction of the effective reflection of the reflecting region. In practice, the period of the grating of the reflecting region can be properly regulated to compensate this portion of difference to make the Bragg wavelengths of the gratings of the two portions keep the same. However, even when such compensation measurement is not carried out, it is anticipated that the variation of the effective refractive index caused by current injection may only lead to very small influence. Simulation is made as follows: gain is produced in the active region when current is injected, and such gain is clamped to the threshold gain after lasing of the laser, and in general condition that the threshold gain approaches 40 cm⁻¹. The reflecting region is optically pumped into transparency by the emission from the laser itself. In such a state, the quantum wells of the waveguide core of the reflecting region neither produce gain nor produce absorption, and a net gain of the waveguide in such condition remains −20 cm⁻¹, therefore a difference between the net gains of the reflecting region and the gain region is approximately 60 cm⁻¹. This portion of gain difference will produce a corresponding difference of effective refractive index. They are connected through the linewidth enhancement factor. As the high-speed directly modulated laser generally adopts an InGaAlAs quantum well material, the linewidth enhancement factor often keeps at between 1 and 2, which means that the difference of the effective refractive indexes between the reflecting region and the gain region is smaller than 0.005. When a length of the active gain region is simulated to be 150 μm and a length of the reflecting region is simulated to be 75 μm, relation between the variation of the effective refractive index and the threshold gain and relation between the effective refractive index and the threshold gain difference between a dominant mode and a side mode are charted, as shown in FIG. 3. It is known that when the variation of the effective refractive index n is controlled within 0.005, the threshold gain always keeps below 40 cm⁻¹, and the threshold gain difference between the dominant mode and the side mode is always larger than 5 cm⁻¹. Generally, the distributed feedback laser having the threshold gain difference between the dominant mode and the side mode being larger than 5 cm⁻¹ is able to achieve good single mode characteristic. It is indicated from simulations that even when the optical gain region and the reflecting region adopt the same grating period, the threshold gain and the side-mode suppression ratio of the laser will not be greatly deteriorated.

To reduce the influence of the reflection of the cleaved facet, the non-output facet of the reflecting region of the laser adopts a window section or a horizontally inclined cleave facet, or is coated with an anti-reflection film, so that the final reflection of the cleavage plane does not affect the performance of the laser.

An output end of the distributed feedback laser is coated with the anti-reflection film, and a reflectivity of the anti-reflection film is optionally smaller than 1%.

To further increase the feedback of the resonant cavity of the laser, a section of grating that is the same as the reflecting region is added to the output end of the laser. The grating is able to provide additional reflection, and functions in reducing a lasing threshold of the laser in general, which enables the laser to work in condition of reducing the length of the active region. However, this part of grating also produces additional loss and therefore reduces the output efficiency of the laser. Compared to the grating of the reflecting region, the grating added to the output end should not be too long.

Unless otherwise indicated, the numerical ranges involved in the invention include the end values. While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A distributed feedback laser, comprising:
an output end comprising an active region, the active region comprising a first grating, and the first grating comprising a λ/4 phase-shift region; and
a non-output end comprising a reflecting region, the reflecting region comprising a second grating having a uniform period;
wherein
a length of the active region is smaller than or equal to 200 μm; and
an end facet of the output end of the laser is coated with an anti-reflection film.

2. The laser of claim 1, wherein the second grating is a Bragg reflective grating having a period A calculated according to the following equation:
$$Λ = \frac{m λ}{2 {n}_{eff}}$$
wherein, m represents a series number of the second grating; λ represents a Bragg wavelength corresponding to the second grating, at which the second grating is capable of producing a maximum reflection; and n_{eff} is an effective refractive index of a waveguide.

3. The laser of claim 2, wherein the series number of the second grating is m=1.

4. The laser of claim 1, wherein a waveguide of the reflecting region and a waveguide of the active region adopt same core layer structures; and a waveguide core layer of the reflecting region adopts active quantum well materials.

5. The laser of claim 1, wherein a length of the reflecting region is regulated by self-definition according to a required reflectivity; the length of the reflecting region and a reflectivity of the reflecting region are in positive correlation; and a maximum reflectivity of the reflecting region exceeds 80%.

6. The laser of claim 2, wherein a length of the reflecting region is regulated by self-definition according to a required reflectivity; the length of the reflecting region and a reflectivity of the reflecting region are in positive correlation; and a maximum reflectivity of the reflecting region exceeds 80%.

7. The laser of claim 1, wherein a coupling coefficient of the second grating of the reflecting region is regulated by self-definition according to a required reflectivity; the coupling coefficient of the reflecting region and a reflectivity of the reflecting region are in positive correlation; and the coupling coefficient is regulated to make the reflectivity of the reflecting region exceed 80%.

8. The laser of claim 2, wherein a coupling coefficient of the second grating of the reflecting region is regulated by self-definition according to a required reflectivity; the coupling coefficient of the reflecting region and a reflectivity of the reflecting region are in positive correlation; and the coupling coefficient is regulated to make the reflectivity of the reflecting region exceed 80%.

9. The laser of claim 1, wherein the period of the second grating of the reflecting region is different from that of the first grating of the active region.

10. The laser of claim 2, wherein the period of the second grating of the reflecting region is different from that of the first grating of the active region.

11. The laser of claim 1, wherein a non-output end facet of the reflecting region adopts a window section, or a horizontally inclined end facet, or a coated anti-reflection film, or a combination thereof.

12. The laser of claim 2, wherein a non-output end facet of the reflecting region adopts a window section, or a horizontally inclined end face, or a coated anti-reflection film, or a combination thereof.

13. The laser of claim 1, wherein a reflectivity of the anti-reflection film of the end facet of the output end is smaller than 1%.
